(19) United States
(12) Patent Application Publication
(10) Pub. No.: US 2007/0063043 A1
(43) Pub. Date: Mar. 22, 2007

(54) Optoelectronic reader and method for reading machine-readable symbols

(75) Inventor: Harley K. Heinrich, Everett, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Intermec IP Corp., Everett, WA (US)

(21) Appl. No.: 11/520,447

(22) Filed: Sep. 12, 2006

Related U.S. Application Data
(60) Provisional application No. 60/719,625, filed on Sep. 21, 2005.

(51) Int. Cl. G06K 7/10

(52) U.S. Cl. 235/454; 235/462.41

(57) ABSTRACT

An optoelectronic reader for reading machine-readable symbols such as barcode symbols employs an optical assembly to focus a non-Gaussian image on an image sensor. The optical assembly may include a substantially diffraction free optical element, such as an annular slit aperture or a conical lens element, for example a conical refracting surface or axicon lens element.

### CROSS-REFERENCE TO RELATED APPLICATION

This application claims the benefit under 35 U.S.C. § 119(e) of U.S. Provisional Patent Application No. 60/719,625, filed Sep. 21, 2005.

### BACKGROUND OF THE INVENTION

1. Field of the Invention

This disclosure generally relates to the automatic data collection (ADC) field, and more particularly to optoelectronic readers operable to read machine-readable symbols, for example barcode symbols, area or matrix code symbols and/or stack code symbols.

2. Description of the Related Art

Optoelectronic readers for reading machine-readable symbols are generally categorized into two groups: 1) moving beam devices commonly referred to as scanners (e.g., laser scanners), and 2) fixed beam devices commonly referred to as imagers (e.g., CCD imagers). Each group has its own relative advantages.

Moving beam devices typically move or scan a light across a target. For example, a scanner may employ a laser diode and a mechanism for moving a laser beam produced by the laser diode across the target. While it may be possible to move the light source itself, scanners typically employ one or more rotating or oscillating mirrors which reflect the laser beam, sweeping the laser beam back and forth across a target, and thereby sequentially illuminating portions of the target along a scan line. Scanners also typically include an optoelectronic sensor, for example one or more photodiodes. The optoelectronic sensor detects the laser light reflected from the target and produces a corresponding analog signal. The scanner may employ a standard lens or retro-collector to focus the reflected light on the optoelectronic sensor. For example, U.S. Pat. No. 6,719,204 describes a Mathieu-Gaussian beam for optical scanners which employs a non-Gaussian optic system for a barcode scanner that has very long range depth of focus relative to comparable Gaussian optics barcode scanning systems. Typically, the scanner, or an associated device, converts an analog signal produced by the optoelectronic sensor into to a digital signal, before decoding the digital signal according to standard decoding schemes.

While fixed beam devices may rely on ambient light, most imagers employ an illumination system. The illumination system typically includes a number of high intensity light emitting diodes (LEDs) arranged to simultaneously flood the entire target with light. Imagers strive for uniform illumination over the entire target. Imagers also include an optoelectronic sensor, e.g., one- or two-dimensional arrays of charge coupled devices (CCDs), and may include a lens system to focus reflected light onto the optoelectronic sensor. A CCD array may be electronically sampled or scanned, to produce a digital signal suitable for decoding.

Imagers advantageously eliminate moving parts, and allow high reading speeds at relatively low cost, but may have limited range and/or depth-of-field. To address such limitations U.S. Pat. No. 5,308,966 and U.S. Pat. No. 5,814,803 both describe using either auto-focus or multi-focal length lens systems for imagers. However, imagers with auto-focus lens systems suffer from delays associated with focusing the imager lens. Imagers with multi-focal imager lenses only work optimally at the multi-focal point distances of the imager lens. Hence there is a need in ADC arts for an optoelectronic reader that can overcome at least some of the aforementioned drawbacks.

### BRIEF SUMMARY

In one aspect, an optoelectronic reader for reading machine-readable symbols comprises an image sensor operable to produce image data based at least on light impinging on the image sensor, an optical assembly positioned to receive light from a machine-readable symbol and to focus a non-Gaussian beam on at least a portion of the image sensor, and an image processing subsystem coupled to receive image data from the image sensor and configured to process the received image data to at least partially resolve information encoded in the machine-readable symbol.

In another aspect, a method of operating a reader for reading machine-readable symbols comprises receiving light from a machine-readable symbol at the reader, focusing the received light to at least a quasi-Bessel point on an image sensor; producing image data based at least in part on the light focused in the image sensor, and processing image data to at least partially resolve information encoded in the machine-readable symbol.

In yet another aspect, an optoelectronic reader for reading machine-readable symbols comprises a housing, a flood illumination light source operable to illuminate a machine-readable symbol, an optical assembly positioned to receive light returned from the machine-readable symbol and to produce a substantially diffraction free beam, an image sensor positioned in the housing to have the substantially diffraction free beam focused on at least a portion thereof by the optical assembly, the image sensor operable to produce image data in response to the substantially diffraction free beam; an image processing subsystem coupled to receive image data from the image sensor and configured to process the received image data to at least partially decode information encoded in the machine-readable symbol.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of an optoelectronic reader reading a machine-readable symbol according to one illustrated embodiment.

FIG. 2 is a functional block diagram of an optoelectronic reader according to one illustrated embodiment.

FIG. 3 is a schematic diagram of an optical assembly of the optoelectronic reader of FIG. 2, focusing a portion of an image of a machine-readable symbol on an image sensor according to one illustrated embodiment.

FIG. 4A is a schematic diagram of an alternative optical assembly of the optoelectronic reader, employing an annular split aperture formed in a diaphragm to produce a non-Gaussian beam according to one illustrated embodiment.

FIG. 4B is a schematic diagram of an alternative optical assembly of the optoelectronic reader, employing a diffractive optical element such as a holographic element to produce a non-Gaussian beam according to one illustrated embodiment.

FIG. 5 is a graph illustrating a point-spread function for a non-Gaussian optical imaging system according to one illustrated embodiment.

FIG. 6 is a graph illustrating a depth of focus of a non-Gaussian optical imaging system according to one illustrated embodiment.

FIG. 7 is a graph illustrating an image of a machine-readable symbol obtained with a non-Gaussian optical imaging system according to one illustrated embodiment.

FIG. 8 is a flow diagram showing a method of operating an optoelectronic reader according to one illustrated embodiment.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well known structures associated with optoelectronic readers such as barcode readers and methods for reading machine-readable symbols such as barcode symbols, area or matrix code symbols and/or stacked code symbols have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the embodiments.

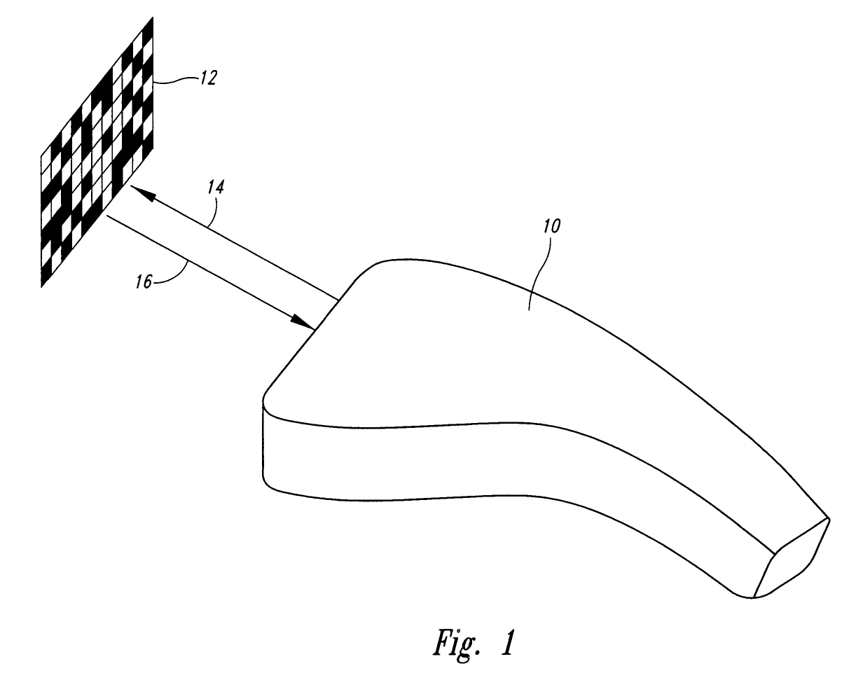

FIG. 1 shows an optoelectronic reader 10 positioned to read a machine-readable symbol 12, for example a barcode symbol, area or matrix code symbol, or stacked code symbol. The optoelectronic reader 10 may optionally illuminate the machine-readable symbol 12 as illustrated by arrow 14, and may receive light returned from the machine-readable symbol 12 as illustrated by arrow 16. In some embodiments, the optoelectronic reader 10 may rely on ambient light reflected from the machine-readable symbol 12.

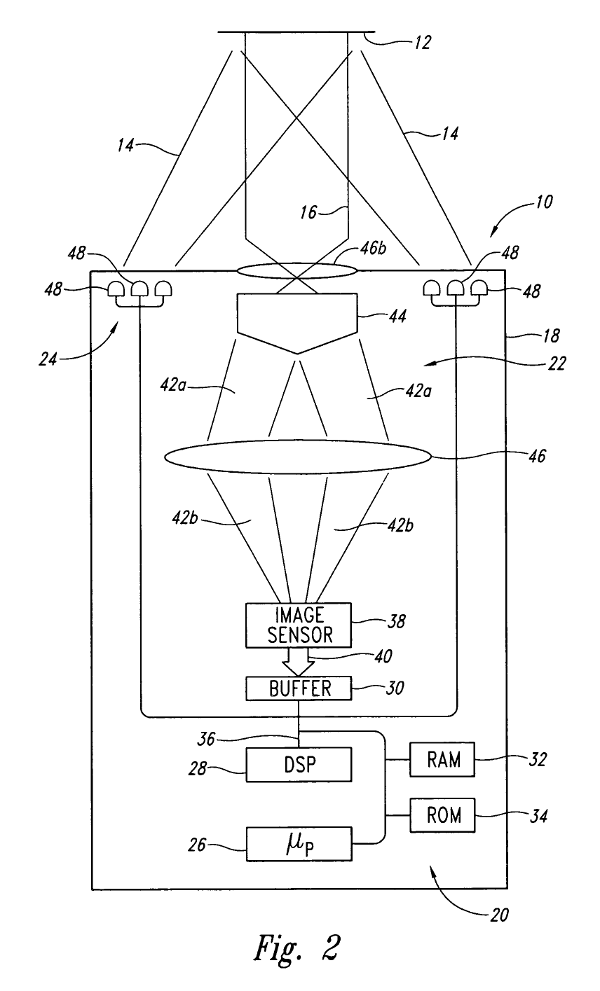

FIG. 2 shows the optoelectronic reader 10 reading the machine readable symbol 12 according to one illustrated embodiment. The optoelectronic reader 10 may include a housing 18, control subsystem 20, optical assembly 22, and optionally illumination subsystem 24.

The control subsystem 20 may include one or more controllers such as microprocessor 26, digital signal processor (DSP) 28 or application-specific integrated circuit (ASIC). The control subsystem 20 may include one or more memories, for example a buffer 30, random access memory (RAM) 32, and/or read-only memory (ROM) 34 coupled to the controllers by one or more busses 36. While illustrated as a single bus 36, the optoelectronic reader 10 may include more than one bus. For example, separate buses 36 may be provide for power, control and data. Where the optoelectronic reader 10 takes a handheld form, power may be supplied from a battery, ultra-capacitor, fuel cell, or other portable power source.

The optoelectronic device 10 also includes an optoelectronic sensor such as an image sensor 38. The image sensor 38 may, for example, take the form of a one- or two-dimensional CCD array, which is operable to transform an image received as light into digital data, for example electrical signals. As illustrated by arrow 40, the image sensor 38 may be coupled to the controller (e.g., DSP 28 via an optional buffer 30 which may temporarily store image data 40 produced by the image sensor 38 until the controller is ready to handle the image data.

The optical assembly 22 may include one or more optical elements positioned to receive light from the machine-readable symbol 12 and to focus a non-Gaussian beam 42a, 42b onto the image sensor 38. The optical assembly 22 may include a substantially diffraction free optical element (e.g., 10-20%), for example as a conical lens element such as a conical refracting surface or axicon lens element 44. The optical assembly 22 may include one or more additional optical lenses, for example a double convex lens 46a positioned between the axicon lens element 44 and image sensor 38 and double convex lens 46b positioned between the axicon lens element 44 and exterior of the housing 18.

The optional illumination subsystem 24 may include one or more light producing transducers, for example light emitting diodes (LED) 48 which may be operable in response to a signal from the microprocessor 26 via the bus 36.

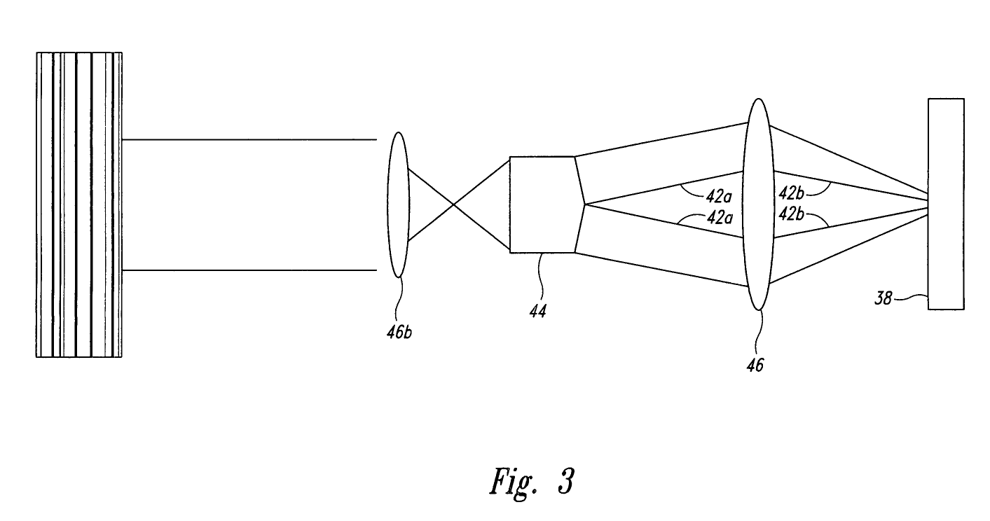

FIG. 3 shows the axicon 44 producing a Bessel beam 42a which is focused by converging lens 46 as beam 42b onto the image sensor 38. The optical assembly 22 may use other elements such as diffractive elements, LCD filters and compound lens surfaces. These non-Gaussian optics may be integrated with conventional Gaussian optical lens elements, such as converging lens 46.

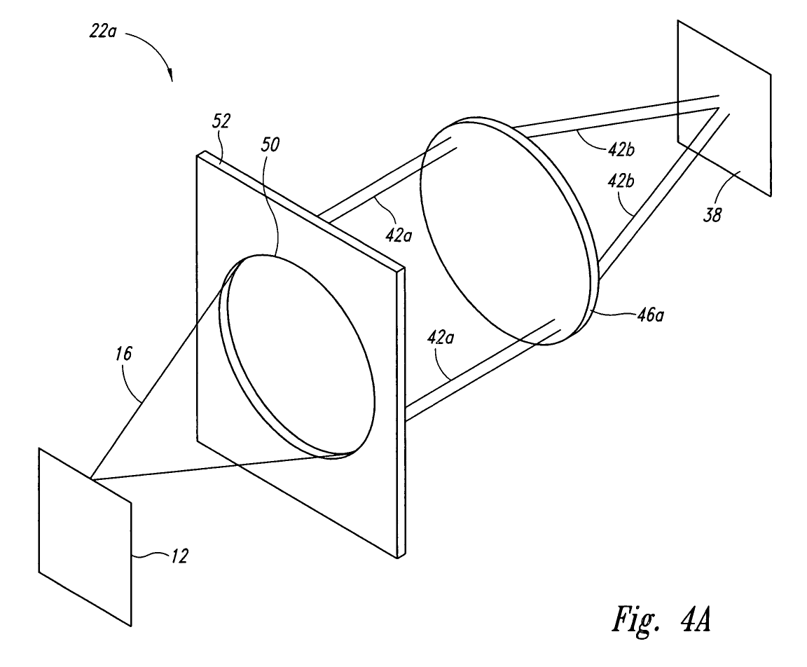

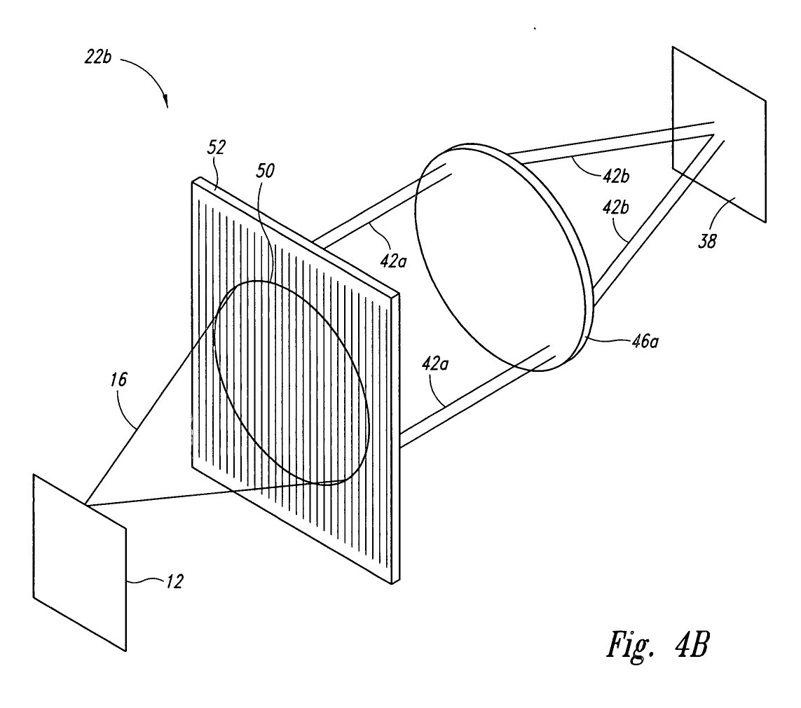

FIG. 4A shows an alternative embodiment of optical assembly 22a, employing an annular split aperture 50 formed in a diaphragm 52 and positioned to focus light 16 from the symbol 12 onto the image sensor 38, optionally via converging lens 46a. The embodiment of FIG. 4A may include one or more additional optical elements, for example a converging lens 46b positioned in a fashion similar to that illustrated in FIGS. 2 and 3.

FIG. 4B shows an alternative embodiment of optical assembly 22b, employing a diffractive optical element such as a holographic element 53 positioned to focus light 16 from the symbol 12 onto the image sensor 38, optionally via converging lens 46a. The holographic element 53 may take the form of holographic film or diffractive optical element. The embodiment of FIG. 4B may include one or more additional optical elements, for example a converging lens 46b positioned in a fashion similar to that illustrated in FIGS. 2 and 3.

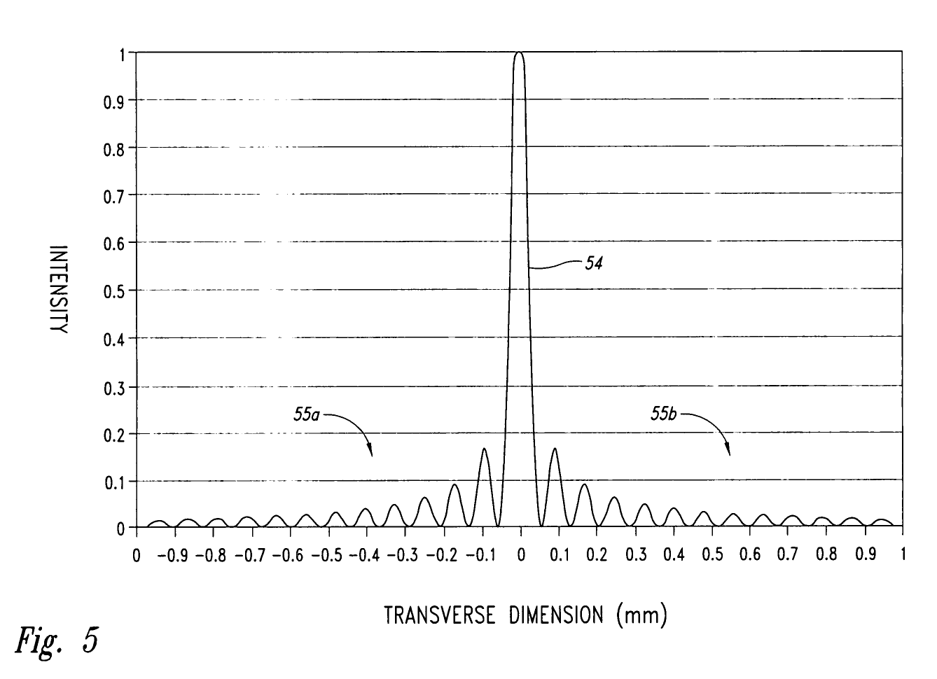

FIG. 5 is a graph showing a point-spread function 54 for a non-Gaussian optical imaging system with intensity plotted along a y-axis and a transverse radial dimension plotted along an x-axis. This point-spread function 54 represents the beam radial profile for an imager lens with a diameter of 2.5 millimeters, an imager lens focal length of 305 millimeters, with wavelength of 632.8 nanometers. Under these conditions, the point-spread function spot size is approximately 70 micrometers and the depth of focus is 80 centimeters. It is noted that the point-spread function 54 for the non-Gaussian optical imaging system contains a significant amount of off-axis content in the wings 55a, 55b. The off-axis content the optical system to have a much larger depth of focus when compared to conventional Gaussian optical systems. However, this off-axis content creates a “gray” background on the image sensor 38 and degrades the overall contrast ratio of the best focus image.

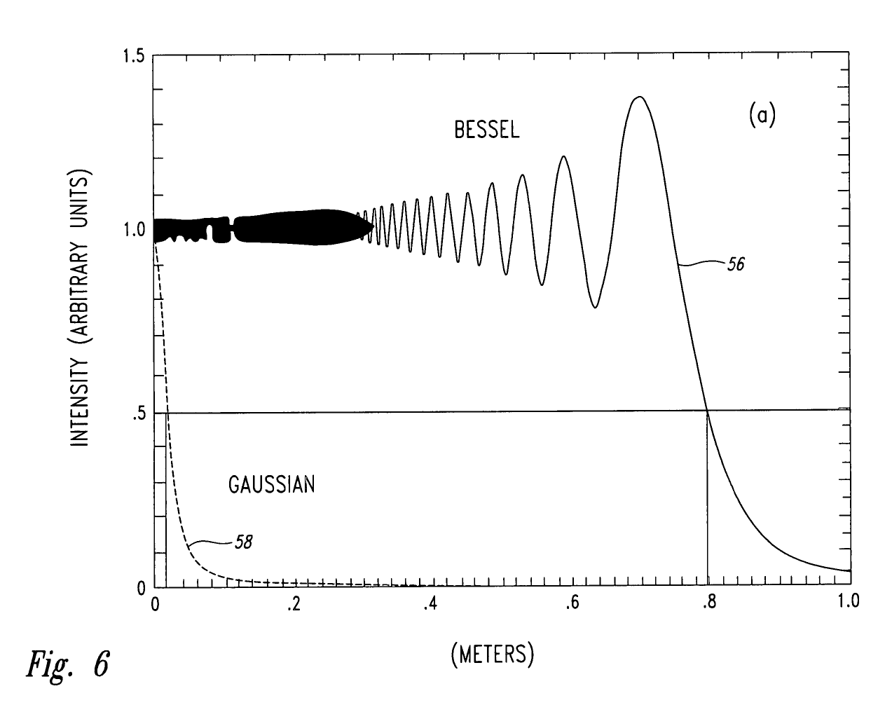

FIG. 6 illustrates a depth of focus of a non-Gaussian optical imaging system particularly producing a Bessel image plotted as 56 in contrast to a Gaussian image plotted as 58. In particular, the example illustrates the possible expansion of the depth of focus on the imaging system relative to a traditional Gaussian imaging optic system. The focus range for the non-Gaussian imaging system is 80 centimeters at 50% intensity, while the Gaussian optical system focus range is less than 1 centimeter, which is an increase of 80 times over the conventional Gaussian optical system.

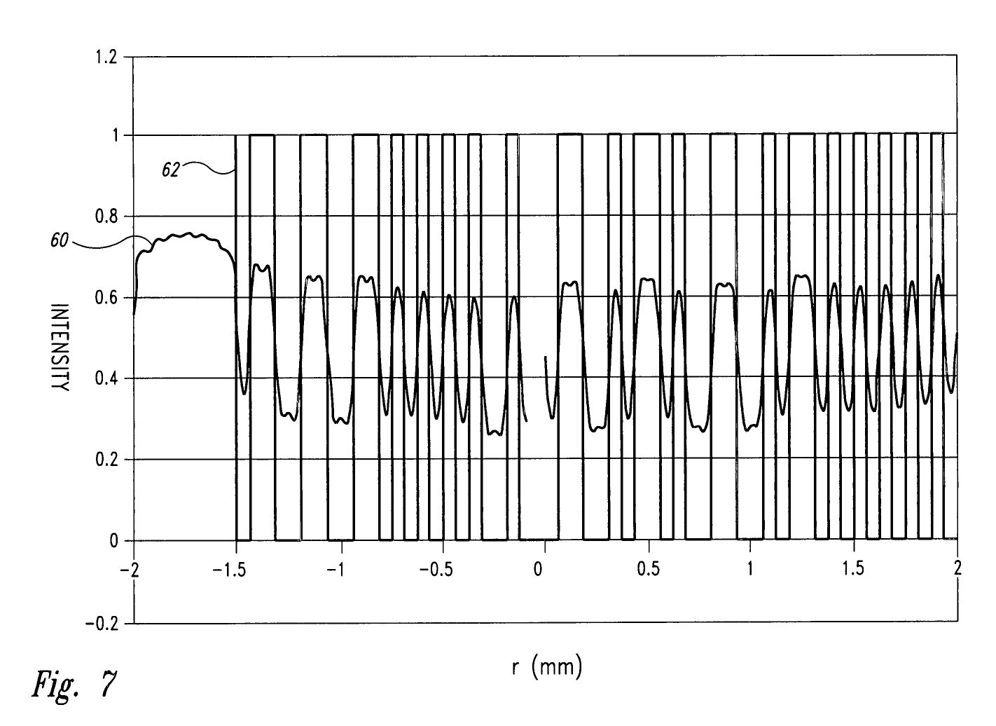

FIG. 7 shows an example of an image 60 that would be attained from the non-Gaussian optical imaging system for a 70 micron (3 mil.) spot over the full 80 centimeter depth of focus. The total optical signal resulting from a random pattern of wide and narrow bars 62 with the beam profile shown in FIG. 5. The pattern is for scanning 63 micron line/spaces over an 80 centimeter depth of field. Notice that the contrast ratio is over 50% even though the depth of focus for the non-Gaussian optical system is 80 times larger than for a comparable Gaussian optical system. FIG. 7 shows that the non-Gaussian beam profile is very effective in scanning barcode patterns, and that the wings 55a, 55b in the optical point-spread function 54 merely contribute to an offset in the baseline of the recovered image.

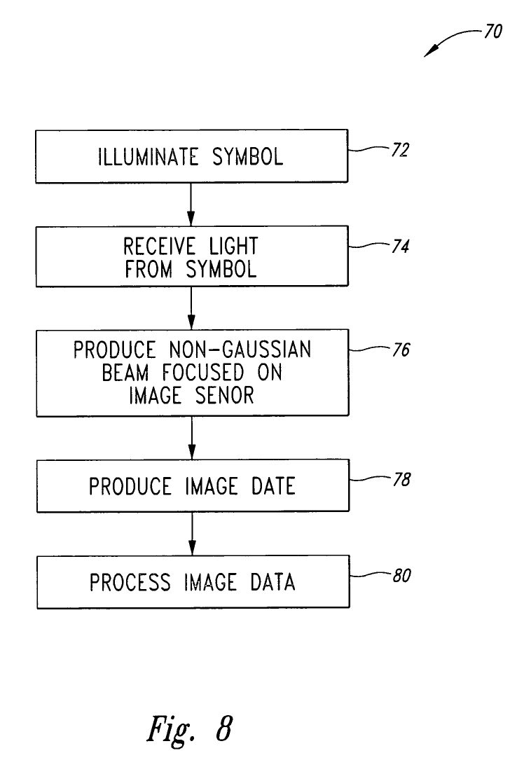

FIG. 8 shows a method 70 of operating the optoelectronic reader 10 according to one illustrated embodiment. At 72, the illumination subsystem 24 optionally illuminates the machine-readable symbol 12. The illumination subsystem 24 may be responsive to a signal from, for example, the microprocessor 26.

At 74, the optoelectronic reader 10 receives light from the machine-readable symbol 12. At 76, the optical assembly 22 focuses a non-Gaussian beam on the image sensor 38. At 78, the image sensor 38 produces image data 40. The image data 40 may be temporarily stored in the optional buffer 30 until one of the controllers is ready to process the image data 40. At 80, the DSP processes the image data 40, for example, decoding the image data according to known or later developed decoding algorithms. Alternatively, or additionally, the microprocessor 26 may process the image data.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein can employ other non-Gaussian optics, not necessarily the exemplary axicon or annular slit aperture optics generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that some of the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/719,625, filed Sep. 21, 2005, are incorporated herein by reference, in their entirety. Aspects of the invention can be modified, if necessary, to employ systems, circuits and concepts of the various patents, applications and publications to provide yet further embodiments of the invention.

These and other changes can be made in light of the above-detailed description. In general, in the following claims, the terms used should not be construed to limit the claims to the specific embodiments disclosed in the specification and the claims, but should be construed to include all optoelectronic readers in accordance with the claims. Accordingly, the invention is not limited by the disclosure, but instead its scope is to be determined entirely by the following claims.

I claim:

1. An optoelectronic reader for reading machine-readable symbols, the optoelectronic reader comprising:
an image sensor operable to produce image data based at least on light impinging on the image sensor;
an optical assembly positioned to receive light from a machine-readable symbol and to focus a non-Gaussian image on at least a portion of the image sensor; and
an image processing subsystem coupled to receive image data from the image sensor and configured to process the received image data to at least partially resolve information encoded in the machine-readable symbol.

2. The optoelectronic reader of claim 1 wherein the image sensor comprises a two-dimensional array of charge coupled devices.

3. The optoelectronic reader of claim 1 wherein the optical assembly comprises at least one substantially diffraction free optical element.

4. The optoelectronic reader of claim 1 wherein the optical assembly comprises at least one annular slit aperture.

5. The optoelectronic reader of claim 1 wherein the optical assembly comprises at least one conical lens element.

6. The optoelectronic reader of claim 1 wherein the optical assembly comprises at least one lens element having a conical refracting surface.

7. The optoelectronic reader of claim 1 wherein the optical assembly comprises at least one diffractive optical element.

8. The optoelectronic reader of claim 1 wherein the optical assembly comprises at least one axicon lens element.

9. The optoelectronic reader of claim 1, further comprising:
a flood illumination light source operable to illuminate the machine-readable symbol.

10. The optoelectronic reader of claim 1, further comprising:
a flood illumination light source; and
an optical assembly to transmit a Gaussian image from the optoelectronic reader to illuminate the machine-readable symbol.

11. A method of operating a reader for reading machine-readable symbols, the method comprising:
receiving light from a machine-readable symbol at the reader;
focusing the received light to at least a quasi-Bessel image on an image sensor;
producing image data based at least in part on the light focused on the image sensor; and
processing image data to at least partially resolve information encoded in the machine-readable symbol.

12. The method of claim 11 wherein focusing the received light to at least a quasi-Bessel image on an image sensor comprises passing the received light through at least one annular slit aperture.

13. The method of claim 11 wherein focusing the received light to at least a quasi-Bessel image on an image sensor comprises passing the received light through at least one conical lens element.

14. The method of claim 11 wherein focusing the received light to at least a quasi-Bessel image on an image sensor comprises passing the received light through at least one axicon lens element.

15. The method of claim 11, further comprising:
flood illuminating the machine-readable symbol with a Gaussian beam of light, wherein receiving light from a machine-readable symbol comprises receiving at least a portion of the Gaussian beam that is reflected by the machine-readable symbol.

16. An optoelectronic reader for reading machine-readable symbols, the optoelectronic reader comprising:
a housing;
a flood illumination light source operable to illuminate a machine-readable symbol;
an optical assembly positioned to receive light returned from the machine-readable symbol and to produce a substantially diffraction free beam;
an image sensor positioned in the housing to have the substantially diffraction free beam focused on at least a portion thereof by the optical assembly, the image sensor operable to produce image data in response to the substantially diffraction free beam;
an image processing subsystem coupled to receive image data from the image sensor and configured to process the received image data to at least partially decode information encoded in the machine-readable symbol.

17. The optoelectronic reader of claim 16 wherein the substantially diffraction free beam produced by the optical assembly is a non-Gaussian beam.

18. The optoelectronic reader of claim 16 wherein the optical assembly comprises at least one annular slit aperture.

19. The optoelectronic reader of claim 16 wherein the optical assembly comprises at least one conical lens element.

20. The optoelectronic reader of claim 16 wherein the optical assembly comprises at least one lens element having a conical refracting surface.

21. The optoelectronic reader of claim 16 wherein the optical assembly comprises at least one axicon lens element.

22. The optoelectronic reader of claim 16 wherein the optical assembly comprises at least one diffractive optical element.
